(19) United States
(12) Patent Application Publication
(10) Pub. No.: US 2003/0144882 A1
(43) Pub. Date: Jul. 31, 2003

(54) Method and program for providing a maximum concentration of a drug additive in a solution

(76) Inventors: Kaivan Talachian, Richmond Hill (CA); Sayeh Radpay, Toronto (CA); Meetali Acharya, Burlington (CA); Eric S. Paul, North York (CA)

Correspondence Address: Wallenstein & Wagner, Ltd., 53rd Floor, 311 S. Wacker Drive, Chicago, IL, 60606-6622, US

(21) Appl. No.: 10/237,168

(22) Filed: Sep. 6, 2002

Related U.S. Application Data
(63) Continuation-in-part of application No. 10/135,180, filed on Apr. 30, 2002.
Application No. 10/135,180 is a continuation-in-part of application No. 10/059,929, filed on Jan. 29, 2002.
(63) Continuation-in-part of application No. 10/159,845, filed on May 31, 2002.
(63) Continuation-in-part of application No. 10/160,429, filed on May 31, 2002.
(63) Continuation-in-part of application No. 10/161,221, filed on May 31, 2002.
(63) Continuation-in-part of application No. 10/160,444, filed on May 31, 2002.
(63) Continuation-in-part of application No. 10/160,565, filed on May 31, 2002.
(63) Continuation-in-part of application No. 10/160,563, filed on May 31, 2002.
(60) Provisional application No. 60/376,655, filed on Apr. 30, 2002.
(60) Provisional application No. 60/376,625, filed on Apr. 30, 2002.
(60) Provisional application No. 60/377,027, filed on Apr. 30, 2002.
(60) Provisional application No. 60/384,717, filed on May 31, 2002.
(60) Provisional application No. 60/385,176, filed on May 31, 2002.
(60) Provisional application No. 60/384,607, filed on May 31, 2002.

(51) Int. Cl. G06F 17/60; G06F 19/00; G01N 31/00

(52) U.S. Cl. 705/2; 702/23

(57) ABSTRACT

A computerized system for providing a maximum concentration of an additive in a solution. The system receives information identifying one or more additives for use in an admixture and generates a message providing a maximum concentration for such additives in the admixture. The system may be used to ensure that additives in prescribed admixtures do not exceed the maximum concentration level.

### RELATED APPLICATIONS

The present application claims the benefit of the following U.S. Provisional Applications: “Medical Delivery and Information System for Use in Health Care Facilities,” Ser. No. 60/377,027, filed Apr. 30, 2002; “System and Method for Integrating Structural Clinical Documentation With Point of Care Treatment of a Patient,” Ser. No. 60/376,625, filed Apr. 30, 2002; “Infusion Therapy System and Method,” Ser. No. 60/376,655, filed Apr. 30, 2002; “System And Method For Supporting Clinical Decisions During Patient Care And Treatment,” Ser. No. 60/384,717, filed May 31, 2002; “Nursing Order Workflow System and Method,” Ser. No. 60/385,176 filed May 31, 2002; “System And Method For Facilitating Orders During Patient Care And Treatment,” Ser. No. 60/384,607, filed May 31, 2002; and incorporates such applications herein by reference.

This application is a continuation-in-part of the following co-pending applications: “Medical Treatment Verification System and Method,” Ser. No. 10/135,180, filed Apr. 30, 2002; “Automated Messaging Center System And Method For Use With a Healthcare System,” Ser. No. 10/159,845, filed May 31, 2002; “Infusion Therapy Bar Coding System and Method,” Ser. No. 10/160,429, filed May 31, 2002; “System and Method for Providing Multiple Units of Measurement,” Ser. No. 10/161,221, filed May 31, 2002; “Healthcare Database Management Offline Backup and Synchronization System and Method,” Ser. No. 10/160,444, filed May 31, 2002; “System And Method For Obtaining Information From A Bar Code For Use With A Healthcare System,” Ser. No. 10/160,565, filed May 31, 2002; “System And Method For Facilitating Patient Care And Treatment,” Ser. No. 10/160,563, filed May 31, 2002; and incorporates such applications herein by reference.

Additionally, the present application is being filed concurrently with and incorporates by reference the following applications: “Method and Program for Creating Healthcare Facility Order Types,” Ser. No. ______; “Method and Program for Identifying Multiple Diluent Solutions for Use in Drug Delivery With a Healthcare System,” Ser. No. ______; and “System and Method for Facilitating Time-Based Infusion Orders,” Ser. No. ______.

### TECHNICAL FIELD

The present invention is generally directed to a method and program for providing a maximum concentration for an admixture, and more particularly to a computerized method and program designed for implementation with a healthcare facility system for providing information relating to a maximum concentration for an additive in an admixture and for calculating and ensuring an additive does not exceed the maximum concentration.

### BACKGROUND OF THE INVENTION

When multiple IV (intravenous) medications are combined, the risk of complications to a patient is very real. For example, the efficacy of one or more drug in the combination can be reduced or a potentially lethal incompatibility can occur. These problems may occur if one or more of the drugs in the combination exceed a prescribed maximum concentration in the IV medication. However, pharmacy and other healthcare facility systems on the market today do not include a customized automatic maximum concentration checking for IV admixtures at the point of entry, point of admixing and/or the point of administration.

### SUMMARY OF THE INVENTION

The present invention is a computerized system that provides the capability to check for the maximum allowed concentration of IV admixtures long before this information is available via a third party standard screening application. The present maximum concentration checking system provides a customized admixture decision support tool that is available at the point of care. Preferably, this system communicates with or is part of a pharmacy or other healthcare facility system.

In one embodiment, a maximum concentration identifying system for use with a pharmacy system or healthcare facility system comprises a computer configured to generate information relating to a first additive for use in an IV medication or admixture for a patient's therapy and a first diluent for use with the first additive. The computer is further configured to generate a maximum concentration level of the first additive in the first diluent. This maximum concentration level is preferably displayed on the computer's monitor. It also may be printed.

The generation of information by the computer is typically in response to input identifying at least one additive and diluent for the admixture received by the computer. The computer processes this information and provides either a non-specific maximum concentration level and/or a specific maximum concentration level in response. The non-specific maximum concentration level is used to define a generic acceptable maximum concentration of an additive in most infusion solutions (e.g., diluents). The non-specific level can be set by the healthcare facility according to its preferred practices and procedures. The specific maximum concentration level is a specific allowed maximum concentration of the particular additive and solution at issue. This information may be stored in a database accessible by the computer. Preferably, the system is set up so that if a specific maximum concentration level is provided, it overrides the non-specific maximum concentration level and will be the one displayed by the computer.

Preferably, the computer includes an interface for communication with a network of additional computers or other similar devises that are part of the healthcare facility system. Such devices may include personal digital assistants (PDAs).

In addition to providing a maximum concentration level for a first additive and diluent, the computer can be configured to generate a maximum concentration level for a second additive, or a plurality of additives, in the first diluent. Again, for each additional additive, the computer may provide a non-specific and/or a specific (if available) maximum concentration level.

In another embodiment, a method of providing a maximum concentration level for an additive in an admixture for use in a patient's therapy comprising the steps of providing a computer for accessing a database containing data associated with a plurality of additives for use in a patient's therapy, receiving information by the computer selecting a first additive for use in an admixture from the plurality of additives and a first diluent and, generating output by the computer providing a maximum concentration level (i.e., non-specific and/or specific) for the first additive in the admixture.

Similar to the above system, the method may also comprise receiving information by the computer selecting a second additive, or a plurality of additives, for the admixture and, generating output by the computer providing a maximum concentration level for each additional additive in the admixture.

The method may further include interfacing the computer with a network of additional computers or other similar devices.

In yet another embodiment, a computer program product for providing a maximum concentration level of an additive in a diluent comprises a computer usable medium having computer readable program code embodied therein, the program code including a first portion for allowing a user to select a first additive for an admixture, a second portion for allowing the user to select a first diluent for the admixture and, a third portion for generating a maximum concentration level (i.e., non-specific and/or specific) for the additive in the admixture.

The computer program may further comprise a fourth portion for allowing a selection of a second additive, or a plurality of additional additives, for the admixture, and a fifth portion for generating a maximum concentration level for each additive in the admixture.

In a further embodiment, a system for ensuring an additive to an admixture does not exceed a maximum concentration level for use in a pharmacy or healthcare facility system comprises a computer configured to receive a prescription order for an admixture having a first additive and a first diluent. The computer is configured to calculate the concentration of the ordered first additive in the first diluent. These numbers are provided with the prescription order. The computer is further configured to compare the calculated concentration of the ordered first additive in the first diluent with a maximum concentration level (i.e., non-specific and/or specific) and, generate a warning message if the calculated concentration for the first additive in the first diluent exceeds a maximum concentration level.

The system may be further configured to receive a second additive, or a plurality of additional additives, in the prescription order, calculate the concentration of the second or additional additives ordered, and compare the calculated concentration of the ordered second additive in the first diluent with a maximum concentration level. The computer is configured to generate a warning message if the calculated concentration for any of the additives exceeds a maximum concentration level.

The computer may be configured to interface with a network of additional computers or other similar devices. For example, the computer may interface with a wireless hand held device that can be utilized at the point of care of a patient.

In a further embodiment, a method for ensuring an additive in an admixture does not exceed a maximum concentration level comprising the steps of receiving information by a computer identifying a first additive and a first diluent for for a prescription order for an admixture for a patient's therapy; calculating by the computer the concentration of the ordered first additive in the admixture; and, generating a message by the computer if the calculated concentration exceeds a maximum concentration level (i.e., non-specific and/or specific).

The method may further include receiving information by the computer of a second additive, or a plurality of additional additives, for the prescription order for the admixture, calculating by the computer the concentration of the ordered second or additional additives in the admixture and, generating a message by the computer if the calculated concentration of any additive in the admixture exceeds a maximum concentration level.

In yet a further embodiment, a computer program product for ensuring an additive to an admixture does not exceed a maximum concentration level, the computer program product comprises a computer usable medium having computer readable program code embodied therein, the program code including a first portion for receiving a prescription order identifying a first additive and a first diluent for an admixture for use in a patient's therapy; a second portion for calculating the concentration of the first additive in the admixture as ordered; and, a third portion for generating a message if the calculated concentration of the first additive in the admixture exceeds a maximum concentration level (i.e., a non-specific and/or specific).

The computer program may further include a fourth portion for receiving a second additive, or a plurality of additional additives, for the prescription order for the admixture, a fifth portion for calculating the concentration of the second or additional additives in the admixture as ordered and, a sixth portion of generating a message if the calculated concentration level of the any additive in the admixture exceeds a maximum concentration level.

Further aspects of the invention are disclosed in the detailed description of the preferred embodiment, the drawings and the claims.

### BRIEF DESCRIPTION OF THE DRAWINGS

FIG. 1 is a screen shot of a Drug (Edit) window in accordance with the present invention; and,

FIG. 2 is a portion of the screen shot of FIG. 1.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present maximum concentration system is preferably used in connection with a medical delivery and information management system for use in hospitals, pharmacies and other similar healthcare facilities (i.e., a healthcare facility system). The preferred healthcare facility system uses a combination of bar coding and wireless technology to support the clinical needs of physicians, pharmacists, nurses and other healthcare personnel (i.e., clinicians). Moreover, the preferred healthcare system allows healthcare professionals and administrators to make better decisions and reduce costs, while improving patient safety and quality of care.

Specifically, among other things, the preferred healthcare system comprises a computer software program integrated with various other healthcare facility systems, that provides for: electronic on-line access to patient information (e.g., medication history, current medications, allergies, reactions) and medication administration information, preferably in the form of an electronic medical record for the patient; instant medication ordering at the patient bedside; clinical screening of medications; an electronic messaging link between physicians, pharmacists and nurses; standardized dosage and special administration instructions; and, an improved quality of record keeping and inventory tracking. Functionality included within the preferred healthcare system can be split between a number of different devices, such as end-user workstations (e.g., personal computers), medication carts with computer interfaces and hand-held computerized devices (e.g., electronic tablets or personal digital assistants). The hand-held devices are preferably operated at the patient bedside. Conventional software code can be used to implement the unique functionality of the systems described herein. The code can be provided on any computer readable or usable medium.

The healthcare facility system preferably includes, or is connected to, a database that provides information relating to each of the drugs or medications that may be utilized for a patient's therapy. The system provides access to this information through a computer terminal, or other devices networked to the system. The drug file may assist the clinicians in determining which drug is appropriate for a given therapy. Additionally, the drug file may be used for purposes of tracking inventory, and for placing orders for use with a patient. The drug file may also provide information relating to administering the drug or medication.

The present invention is a maximum concentration checking system that can be utilized as an admixture decision support tool available for clinicians at the healthcare facility. The system can be utilized to check the concentration levels of various admixtures used by the healthcare facility in the treatment of patients, and provide a warning if a requested admixture (e.g., a prescription) exceeds the maximum concentration level.

The system can be configured to provide a non-specific maximum concentration level. This parameter is used to define a generic acceptable maximum concentration of an additive in most infusion solutions. The non-specific maximum concentration level can be determined by the healthcare facility to implement its best practice and procedures. This parameter can be stored in a database, and displayed by the computer along with other information concerning a selected admixture.

The system can also be configured to provide a specific maximum concentration level for a particular additive and diluent. This parameter is a specific allowed maximum concentration of a selected additive in a defined solution (i.e., diluent). Again, this parameter can be stored in a database, and displayed by the computer.

At the time of order entry the system calculates the concentration of each additive in an admixture and ensures that each additive does not exceed the maximum concentration defined in the drug file. If the system does not include a specific maximum concentration for an ordered admixture, the non-specific maximum concentration is used. However, if a specific maximum concentration is defined for a solution, it overrides the non-specific maximum concentration in determining whether an additive exceeds the maximum concentration.

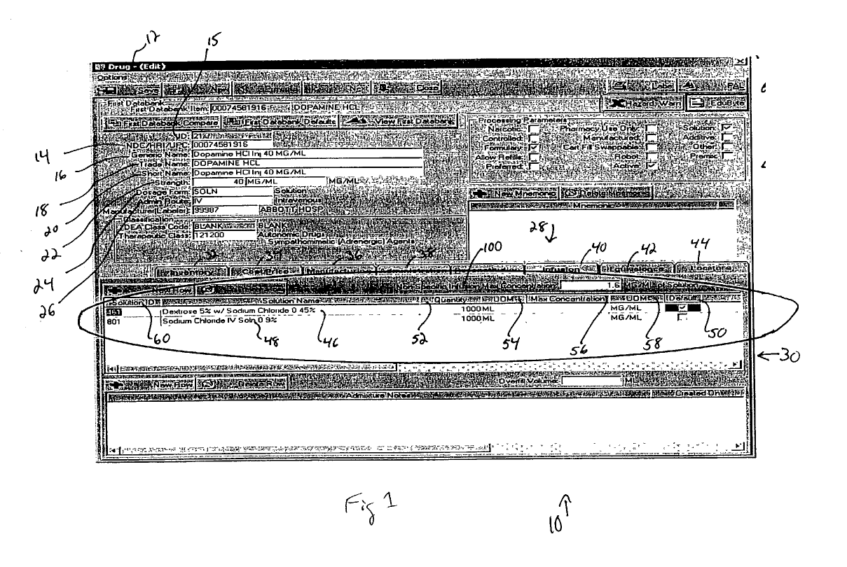

Referring to FIG. 1, a Drug (Edit) screen shot or window 12 of a drug file for a computerized healthcare facility system is shown. The Drug (Edit) window 12 can be used to provide a variety of information concerning a selected drug or medication stored in the database of the system. The window 12 may also be used for selecting a drug or otherwise ordering a drug for use in a patient's therapy (e.g., as a prescription to the pharmacy department of a hospital). Although the Drug (Edit) window 12 can provide information relating to a large variety of drugs or medications used by the healthcare facility, the present invention is concerned with those drugs or medications that are added to a solution or diluent (i.e., a diluting agent). Such drugs or medications are referred to herein as “additives.” A typical use for an additive, is to combine the additive with a diluent for use in an infusion process for a patient.

The Drug (Edit) window 12 provides fields for an identification number 14 and hospital control numbers 15 associated with a particular drug; a generic name 16 of the drug; a trade name 18 of the drug; a short name of the drug 20; the strength 22 of the drug; the drug's dosage form 24; and an administration route 26 for the drug. In the example shown in FIG. 1, the trade name (and short name) of an additive is given as Dopamine HCL Inj 40 MG/Nm. The strength is 40 MG/NM, and the dosage form is a solution. The window 12 indicates that this additive is administered via an IV (i.e., intravenous).

Additionally, in the window 12 shown in FIG. 1, tabs 28 are provided to link to subwindows 30 with further information relating to the selected drug. For example, tabs 28 may be provided for inventory 32 (e.g., status and tracking of drug supplies at the facility); cost/price 34; manufacturing 36; administration 38; infusion 40; equivalence 42 and locators 44.

The infusion tab 40 (shown open in FIG. 1) identifies a first diluent 46 (Dextrose 5% w/Sodium Chloride 0.45%) and a second diluent 48 (Sodium Chloride IV Soln 0.9%), that can be used with the additive in a solution name box 49. Thus, a clinician desiring to administer the selected additive to a patient, can select either the first diluent or the second diluent for the IV infusion. This ability provides a degree of flexibility in the care of the patient. Although only a first and a second diluent are identified for the Dopamine additive shown in FIG. 1, other additives may identify more than two diluents that may be used.

The infusion tab 40 provides a Default checkbox 50 for selecting one of the identified diluents as the default diluent. Thus, a healthcare facility can designate what it considers the best or most appropriate diluent for use by making such a diluent the default.

The infusion tab 40 also provides additional information relating to the diluent. For example, the quantity 52 and unit of measure (UOM) 54 (i.e., the default volume) can be provided. The system also provides for allowing a user (typically a designated clinician at the healthcare facility) to add a diluent to the window for an additive. First, a particular additive is selected and brought up in the Drug (Edit) window 12. A user can select a new row function to add the additional diluent. Next, the user can right click the ID box 60 or otherwise link to a list of possible diluents. The system can be configured to automatically fill the ID box 60 as well as the solution (i.e., diluent) name box 49 and the quantity box 52 upon selection of a diluent from the list.

In accordance with the present invention, a specific maximum concentration level allowed field 56 is provided. This field indicates the maximum allowed concentration level of the item, which you are defining the diluent for, in a milliliter of the diluent. For example, if the user selects Dextrose 5% as one of the diluents for Potassium Chloride, the maximum allowed concentration of the potassium in Dextrose is 80 mEq/L or 0.08 mEq/ml. Although not shown in FIG. 1, this number would be displayed if the user selected a Dextrose 5% and Potassium Chloride admixture. The specific maximum concentration level number may be different for different additives and/or diluents.

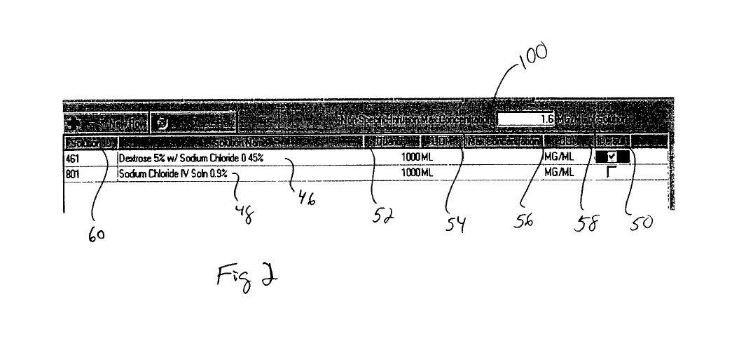

If a specific maximum concentration level for an additive and diluent is defined, the system will use that value during order entry of the additive and diluent. As shown in FIG. 2, if no specific maximum concentration level is defined, the system will display a non-specific maximum concentration level 100. Information concerning specific combinations of additives and solutions, as well as the non-specific maximum concentration level, can be stored in a database. The computer can then look up such information as needed.

In a healthcare facility system that allows the users (e.g., clinicians) to order admixtures (e.g., from the pharmacy department of the facility) through the computerized system, the present invention can be used to ensure that the admixture does not contain additives that exceed the maximum concentration level. Upon receipt of an order (e.g., a prescription), the system calculates the concentration level(s) of the ordered additive(s) and compares the calculated levels with the specific maximum concentration level(s) (if available), or the non-specific maximum concentration level(s). If an additive exceeds the maximum concentration level, the system can display a warning message advising the pharmacist and/or user. In certain embodiments of the invention the user may be able to override the warning and maintain the order as prescribed notwithstanding the indication that an additive will exceed the maximum concentration level. In such instances, the system can be configured to require the requesting user to enter a note to the patient's file explaining the reason for overriding the warning generated by the system.

Although described in connection with an elaborate healthcare facility system, the functionality of the maximum concentration identification system described herein, could also be a stand alone product. Alternatively, the maximum concentration identification system may be part of a system that does not function like the healthcare facility system described.

While specific embodiments have been illustrated and described, numerous modifications are possible without departing from the spirit of the invention, and the scope of protection is only limited by the scope of the accompanying claims.

What is claimed is:

1. A maximum concentration identifying system for use with a pharmacy system or healthcare facility system comprising
a computer configured to generate information relating to a first additive for use in an IV medication for a patient's therapy;
the computer configured to generate information relating to a first diluent for use with the first additive; and,
the computer configured to generate a maximum concentration level of the first additive in the first diluent.

2. The maximum concentration identifying system of claim 1 wherein the maximum concentration level is a non-specific maximum concentration.

3. The maximum concentration identifying system of claim 1 wherein the maximum concentration level is a specific maximum concentration defined for the first additive and first diluent.

4. The maximum concentration identifying system of claim 1 wherein the computer includes an interface for communication with a network of additional computers.

5. The maximum concentration identifying system of claim 1 further comprising the computer configured to receive information selecting the first additive.

6. The maximum concentration identifying system of claim 2 further comprising the computer configured to receive information selecting the first diluent.

7. The maximum concentration identifying system of claim 1 further comprising the computer configured to generate a maximum concentration level for a second additive in the first diluent.

8. The maximum concentration identifying system of claim 1 further comprising the computer configured to generate a maximum concentration level for a plurality of additional additives in the first diluent.

9. A method of providing a maximum concentration level for an additive in an admixture for use in a patient's therapy comprising the steps of:
providing a computer for accessing a database containing data associated with a plurality of additives for use in a patient's therapy;
receiving information by the computer selecting a first additive for use in an admixture from the plurality of additives;
receiving information by the computer selecting a first diluent for use with the additive; and,
generating output by the computer providing a maximum concentration level for the first additive in the admixture.

10. The method of claim 9 wherein the maximum concentration level is a nonspecific maximum concentration level.

11. The method of claim 9 wherein the maximum concentration level is a specific maximum concentration level for the first additive and the first diluent.

12. The method of claim 9 further comprising the steps of:
receiving information by the computer selecting a second additive for the admixture; and,
generating output by the computer providing a maximum concentration level for the second additive in the admixture.

13. The method of claim 9 further comprising the steps of:
receiving information by the computer selecting a plurality of additional additives for the admixture; and,
generating output by the computer providing a maximum concentration level for each of the plurality of additional additives.

14. The method of claim 9 further comprising:
interfacing the computer with a network of additional computers.

15. A computer program product for providing a maximum concentration level of an additive in a diluent, the computer program product comprising:
a computer usable medium having computer readable program code embodied therein, the program code including
a first portion for allowing a user to select a first additive for an admixture;
a second portion for allowing the user to select a first diluent for the admixture; and,
a third portion for generating a maximum concentration level for the additive in the admixture.

16. The computer program of claim 15 wherein the third portion generates a nonspecific maximum concentration level.

17. The computer program of claim 15 wherein the third portion generates a specific maximum concentration level.

18. The computer program of claim 15 further comprising a fourth portion for allowing a selection of a second additive for the admixture, and a fifth portion for generating a maximum concentration level for the second additive in the admixture.

19. The computer program of claim 15 further comprising a fourth portion for allowing selection of a plurality of additional additives for the admixture, and a fifth portion of generating a maximum concentration level for each of the plurality of additional additives.

20. A system for ensuring an additive to an admixture does not exceed a maximum concentration level for use in a pharmacy or healthcare facility system comprising:
a computer configured to receive a prescription order for an admixture having a first additive and a first diluent;
the computer configured to calculate the concentration of the ordered first additive in the first diluent;
the computer configured to compare the calculated concentration of the ordered first additive in the first diluent with a maximum concentration level; and,
the computer configured to generate a warning message if the calculated concentration for the first additive in the first diluent exceeds a maximum concentration level.

21. The system of claim 20 wherein the maximum concentration level is a nonspecific concentration level.

22. The system of claim 20 wherein the maximum concentration level is a specific concentration level for the first additive and first diluent.

23. The system of claim 20 further comprising:
the computer configured to receive a second additive in the prescription order;
the computer configured to calculate the concentration of the ordered second additive in the first diluent;
the computer configured to compare the calculated concentration of the ordered second additive in the first diluent with a maximum concentration level; and,
the computer configured to generate a warning message if the calculated concentration for the second additive in the first diluent exceeds a maximum concentration level.

24. The system of claim 20 further comprising:
the computer configured to interface with a network of additional computers.

25. The system of claim 24 wherein one of said additional computers is a wireless hand held device that can be utilized at the point of care of a patient.

26. A method for ensuring an additive in an admixture does not exceed a maximum concentration level comprising the steps of:
receiving information by a computer identifying a first additive and a first diluent for a prescription order for an admixture for a patient's therapy;
calculating by the computer the concentration of the ordered first additive in the admixture; and,
generating a message by the computer if the calculated concentration exceeds a maximum concentration level.

27. The method of claim 26 wherein the maximum concentration level is a nonspecific maximum concentration level.

28. The method of claim 26 wherein the maximum concentration level is a specific maximum concentration level for the first additive and first diluent.

29. The method of claim 26 further comprising the steps of:
receiving information by the computer of a second additive for the prescription order for the admixture;
calculating by the computer the concentration of the ordered second additive in the admixture; and,
generating a message by the computer if the calculated concentration of the second additive in the admixture exceeds a maximum concentration level.

30. The method of claim 26 further comprising the steps of:
receiving information by the computer of a plurality of additional additives for the prescription order for the admixture;
calculating by the computer the concentration of each of the plurality of additional additives in the admixture; and,
generating a message by the computer if the calculated concentration any of the additional additives in the admixture exceeds a maximum concentration level.

31. A computer program product for ensuring an additive to an admixture does not exceed a maximum concentration level, the computer program product comprising:
a computer usable medium having computer readable program code embodied therein, the program code including
a first portion for receiving a prescription order identifying a first additive and a first diluent for an admixture for use in a patient's therapy;
a second portion for calculating the concentration of the first additive in the admixture as ordered; and,
a third portion for generating a message if the calculated concentration of the first additive in the admixture exceeds a maximum concentration level.

32. The computer program product of claim 31 wherein the maximum concentration level is a non-specific maximum concentration level.

33. The computer program product of claim 31 wherein the maximum concentration level is a specific maximum concentration level for the first additive and the first diluent.

34. The computer program product of claim 31 further comprising:
a fourth portion for receiving a second additive for the prescription order for the admixture;
a fifth portion for calculating the concentration of the second additive in the admixture as ordered; and,
a sixth portion of generating a message if the calculated concentration level of the second additive in the admixture exceeds a maximum concentration level.

35. The computer program product of claim 31 further comprising:
a fourth portion for receiving a plurality of additional additives for the prescription order for the admixture;
a fifth portion for calculating the concentration of each of the plurality of additional additives in the admixture as ordered; and,
a sixth portion of generating a message if the calculated concentration level of any of the plurality of additional additives in the admixture exceeds a maximum concentration level.
